(19) United States
(12) Patent Application Publication
(10) Pub. No.: US 2016/0026751 A1
(43) Pub. Date: Jan. 28, 2016

(54) Method And Means For Designing And/or Operating A Robot

(71) Applicant: KUKA Roboter GmbH, Augsburg (DE)

(72) Inventor: Steffen Walther, Munich (DE)

(21) Appl. No.: 14/807,277

(22) Filed: Jul. 23, 2015

(30) Foreign Application Priority Data
Jul. 24, 2014 (DE) 10 2014 011 012.5

(51) Int. Cl. G06F 17/50

(52) U.S. Cl. CPC G06F 17/5086; Y10S 901/02; Y10S 901/28

(57) ABSTRACT

A method for designing and/or operating a robot includes determining several potential contacts and establishing a contact-specific quantity for each of these contacts. The contacts are assigned to different groups and, in particular for selected groups, at least one group-specific quantity based on contact-specific quantities of contacts assigned to this group is determined. The contact-specific quantities and/or at least one group-specific quantity are determined in dependence of a potential medical harm to a person.

### TECHNICAL FIELD

The present invention relates to a method and means for designing and/or operating a robot as well as a computer program product for implementing such a method.

### BACKGROUND

When persons are present within a robot's radius of action, in particular to cooperate with the robot, a colliding robot can result in contact between the robot and these persons and/or the environment.

A method for controlling a robotic device is therefore known from DE 10 2013 212 887 A1, in which the movement of a robot-controlled end effector is monitored and adjusted to take account of medical injury parameters. To this end, allowable maximum speeds are defined for different relevant points (“points of interest” POIs). The most conservative speed limit is then selected from among all points, and the movement of the robot is monitored and adapted to comply with this limit.

The object of the present invention is to improve the designing and/or operation of a robot.

### SUMMARY

According to one aspect of the present invention, in particular in a partially or fully automated procedure, a hardware and/or software-engineered means or the processing of the program code of a computer program product stored on a computer-readable medium are used to design and/or operate a robot, whereby several potential contacts are determined and a contact-specific quantity is ascertained for each of these contacts in dependence of a potential medical harm to a person from this contact.

In one embodiment, the robot has at least three, in particular at least six, in particular at least seven degrees of freedom or joints and/or a controller that may inventively comprise a means for designing and/or operating the robot. In one embodiment, the robot has an end effector or a tool such as a gripper, a welding tongs or similar, which for the purpose of a more compact description here, may be part of the robot in the sense of the present invention. In another embodiment, the robot however consists only of several permanently pivotally interconnected links and drives for actuating the links, which join a mobile or an environmentally-fixed base to an end flange or a tool flange for detachably fastening a robot-guided end effector or tool.

According to one aspect of the present invention, the contacts are assigned to different groups and, in particular for all or for selected groups, respectively one or more group-specific quantities are determined on the basis of contact specific quantities of contacts assigned to this group.

By consolidating contacts and additionally determining group-specific quantities, in one embodiment the contacts or the contact-specific quantities can be determined and/or evaluated more advantageously. For example, a group can be identified in which the contacts show above-average contact-specific quantities, for example, a particularly high medical risk of damage or a particularly restricting speed limit.

The above describes in particular a risk assessment of the potential contacts by means of contact-specific quantities, which are determined in dependence of a potential medical harm to a person resulting from the respective contact. The group-specific quantities are then based on this risk assessment.

Similarly, contact-specific quantities can also initially be identified that (co)determine or influence a potential medical harm to a person resulting from the respective contact, or upon which a potential medical harm to a person resulting from the respective contact depends, for example, a contact speed or an inertia or a mass. Group-specific quantities based on these contact-specific quantities can then be established in dependence of a potential medical harm to a person resulting from the respective contact. In other words, a risk assessment can also—or if necessary first—be carried out only for the group-specific quantities.

Thus for example, a maximum permissible speed for avoiding inadmissible medical harm to a person can be determined for the respective contacts as contact-specific quantities, i.e. already based on a risk assessment of the respective contact. The group-specific quantity can then in turn specify, for example, the respective lowest maximum permissible speed of a group or the number of contacts, whose maximum permissible speed falls below a threshold.

Similarly, it is initially possible to determine a speed as a contact-specific quantity for each of the respective contacts, for example in the direction of the contact impact or the normal direction, i.e. without risk assessment of the respective contact. The group-specific quantity can then, for example, specify the number of contacts, whose speed exceeds a maximum allowed value for avoiding impermissible medical harm to a human. In this case, therefore, the group-specific quantities are determined based on a risk assessment of the respective contact.

Correspondingly, according to one aspect of the present invention, in particular in a partially or fully automated procedure, a hardware and/or software-engineered means or the processing of the program code of a computer program product stored on a computer-readable medium are used to design and/or operate a robot, whereby several potential contacts are determined, a contact-specific quantity is ascertained for each of these contacts, the contacts are assigned to different groups and, particularly for all or selected groups, respectively one or more group-specific quantities are determined based on contact-specific quantities of the contacts assigned to this group and in dependence of a potential medical harm to a person by the contacts, the basis upon which the group-specific quantity is determined.

This consolidation of contacts, possibly still without a risk assessment, and the additional determination of group-specific quantities on the basis of a risk assessment can, in one embodiment again make it possible to determine and/or evaluate the contacts or the contact-specific quantities more advantageously. Thus, for example, a group can be identified whose contacts have above-average contact-specific quantities, for example very high speeds or reflected inertias, and which therefore represent a particularly high risk and must be treated with greater priority.

In one embodiment, groups are or will be specified, in particular in a fully or partially automated procedure and/or by user input, and contacts are assigned to these specified groups, in particular in a fully or partially automated procedure and/or by user input. For example, the contacts that may occur on an arm of the robot, can be assigned to a group representing this arm. It is then possible to determine whether the arm has a particularly high medical risk of damage, and the arm can then be specifically designed and/or operated, in particular moved, differently.

Additionally or alternatively, groups are or will be (newly) defined, in particular in a fully or partially automated procedure and/or by user input, by contacts that have been predefined, in particular in a fully or partially automated procedure and/or by user input. Thus predefined contacts can be optionally combined into different groups relevant for designing and/or operating, for example, as an alternative to a group of contacts moved by the robot and the complementary group of unmoved contacts.

In one embodiment the contacts are assigned to at least two different groups or they are or will be specified or defined for at least two different groups. In one improvement the number of groups corresponds to or exceeds the number of joints or degrees of freedom of the robot, so that in particular at least one group is assigned to each robot link.

In one embodiment, at least two contacts each are or will be assigned to at least one group, preferably each to at least two groups. This will facilitate an embodiment in which in particular complex movements can be taken into account.

In one embodiment, one or more group-specific quantities are each determined on the basis of a comparison of contact-specific quantities within a group to or with each other. In particular, such a group-specific quantity can be determined on the basis of a maximum or minimum contact-specific quantity within the group, in particular it can be such a quantity. Additionally or alternatively, such a group-specific quantity can comprise, in particular be, a relative sort of the contact-specific quantity within the group according to its quantity and/or a statistical quantity of the contact-specific quantity within the group, in particular a mean, a standard deviation, or the like.

Thus, for example, the group-specific quantity can be the respective maximum contact-specific quantity within the group, so that groups having a particularly high medical risk of damage can be identified.

Additionally or alternatively, in one embodiment, one or more group-specific quantities are determined on the basis of a comparison of contact-specific quantities with one or more predetermined threshold values within the group. In particular, such a group-specific quantity can comprise, in particular be, an absolute sort of the contact-specific quantity within the group into the classes specified by the threshold value(s).

Thus, for example, the group-specific quantity can be the number of those contact-specific quantities within the group, that exceed a predetermined threshold value, so that those groups with a particularly high number of risk-indicating contacts can be identified.

In one embodiment, one or more group-specific quantities are each determined on the basis of an averaging of, in particular either selected or all, contact-specific quantities within the group. In this way, for example, groups with many contacts can be represented by a single group-specific quantity.

In one embodiment, one or more group-specific quantities are compared with each other. In particular, it is then possible to determine a maximum or minimum group-specific quantity within the groups, and/or the groups can be sorted relatively to each other on the basis of their group-specific quantities.

Additionally or alternatively, in one embodiment one or more group-specific quantities are compared with one or more predetermined threshold values. In particular, it is thus possible to sort the groups absolute or into classes defined by the threshold values.

In particular, the above described procedure makes it easier to analyze potential contacts within a particular group. For example, where a group represents an arm of the robot, it is possible to determine which contact limits its speed most.

Additionally or alternatively it is possible to advantageously analyze groups together. Thus, for example, it can be determined which of the robot links, represented by respective groups, has the strongest limiting effect on the speed of the end effector.

In one embodiment, contacts, in particular in a partially or fully automated procedure, are assigned to groups in dependence of their position relative to structural elements, in particular components or links or component groups or link groups of the robot. In an example it is thus possible to assign the contacts of one robot hand and one end effector of the robot to a respective own group. Similarly, the contacts of the robot hand and of the end effector can also be assigned to a common group to, for example, distinguish these from a group of robot arm contacts and/or base-fixed contacts and/or a group of environmentally-fixed contacts, and to handle these together independently of the others.

Additionally or alternatively, contacts, in particular in a fully or partially automated procedure, are assigned to groups depending on the robot's joint coordinates that determine their kinematics. Thus, for example, all contacts whose speed (also) depends on a movement of a robot hand, are combined into a group whose group-specific quantity then (also) depends on the motion of a robot hand, in order to thus determine the contact or contacts that restrict this movement most significantly.

As already explained, in one embodiment, contacts are partly or fully automatically assigned to groups, for example on the basis of their position relative to structural elements. Additionally or alternatively, contact groups can also optionally be assigned by user input. In this way, the user can optionally compile groups, for example, to analyze the maximum or mean medical harm potential of an end effector.

In one embodiment, at least one contact is or will be assigned to at least two different groups. For example, a contact on an end effector could on the one hand be assigned to a group representing the end effector and, on the other hand, to a group representing the entire robot. In another embodiment, each contact is or will be assigned uniquely to one group maximum.

In one embodiment, at least one group-specific quantity and/or at least one contact-specific quantity each specify one potential medical harm to a person or evaluates or weighs it, in particular in accordance with a medical classification, such as the A0-classification. In a very simple example, a quantity such as “0” can specify no harm, a quantity “1” a superficial and temporary harm, such as an abrasion, a quantity “2” an in-depth and temporary harm, such as a bone fracture, a quantity “3” an in-depth and permanent harm, such as the (functional) loss of a limb or organ, and a quantity “4” a lethal harm.

In one embodiment, at least one group-specific quantity and/or at least one contact-specific quantity each specify an allowable kinematic quantity, in particular geometry, position, speed and/or acceleration, in particular to avoid unacceptable medical harms. Thus, in one example, the quantity could comprise, in particular be, the absolute speed or the maximum permissible speed to avoid impermissible medical harm, as described in the aforementioned DE 10 2013 212 887 A1, to which supplementary reference is made and whose contents is expressly included in the present disclosure. Likewise, in an example the quantity can comprise, in particular be, the maximum curvature or the maximum permissible curvature of an edge in order to avoid impermissible medical harm.

Additionally or alternatively, in one embodiment at least one group-specific quantity and/or at least one contact-specific quantity each specify an allowable dynamic quantity, in particular stiffness, damping and/or, in particular reflected inertia, in particular to avoid unacceptable medical harms. Thus, in an example the quantity can comprise, in particular be, the reflected inertia or the maximum permissible reflected inertia to avoid impermissible medical harm. Likewise, in one example, the quantity can comprise, in particular be, the maximum stiffness or the maximum permissible stiffness of a surface to avoid impermissible medical harm. A (potential) contact determined in the sense of the present invention can have, in particular be, in particular a single-dimensional or multi-dimensional quantity, whose parameters can describe or specify a contact geometry, in particular a contactable or contacting contour, a surface condition, in particular roughness, hardness or the like, a kinematic contact quantity, in particular an absolute or relative position and/or orientation, relative speed, and/or relative acceleration of, in particular a robot-fixed or environmentally-fixed, reference, and/or a dynamic contact quantity, in particular a contact stiffness, contact damping and/or, in particular, reflected inertia. In this respect also, reference is additionally made to the aforementioned DE 10 2013 212 887 A1, whose content is expressly incorporated into the present disclosure. Thus, for example, a contact in the sense of the present invention may comprise, in particular be, a POI, as disclosed in this DE 10 2013 212 887 A1.

Accordingly, in one embodiment, a contact geometry, a kinematic contact quantity, in particular a position, an orientation and/or a speed and/or a dynamic contact quantity, in particular a contact stiffness,—damping and/or inertia are determined for a contact, if the latter is specified.

In one embodiment, the method is carried out while the robot is in operation. Accordingly, robot operation is in particular understood to mean controlling and/or monitoring the robot, for example as disclosed in the aforementioned DE 10 2013 212 887 A1, to which reference is additionally made in this respect, and whose content is expressly incorporated into the present disclosure.

Thus, for example, instead of monitoring all contact-specific quantities in operation, it is possible to monitor only group-specific quantities, such as the maximum contact-specific quantities within the respective group, and the robot can be operated in such a way that these meet a specified condition, for example that they do not exceed a permissible maximum speed.

Additionally or alternatively, the method is performed in advance, in particular prior to a movement, preferably activation, of the robot. Accordingly, operating the robot is in particular also understood to mean (offline) path planning, design is in particular understood to mean a specification, design, modification and/or a selection, for example, of modules, tools or the like.

Thus, for example, a component can be identified in advance and structurally specifically modified in such a way that its group-specific quantity indicates the greatest health harm potential.

In one embodiment, one or more of the contacts are robot-fixed. During design and/or operation of a robot it is thus in particular possible to take into account a potential harm to a person resulting from a direct collision with it.

In addition or alternatively, in one embodiment one or several of the contacts are environmentally-fixed. It is thus in particular possible to take into account a potential harm to a person whom the robot shoves, pushes or knocks or squeezes against the environment, when the robot and/or a cell of the robot, in which the latter is arranged and/or acts, and/or an application of the robot is being designed and/or operated. In a simple example, a contact speed of an environment-fixed contact could lie on a straight line to the nearest robot-fixed contact, and its speed could be equal and opposite, because for a potential medical harm it is approximately equivalent whether a person is, for example, pressed against an environmental edge by the robot or whether the robot presses such an edge against the person.

A means within the sense of the present invention can be technically developed by hardware and/or software, in particular a, preferably with a memory and/or bus system, data-connected or signal-connected, in particular digital, processing unit, in particular microprocessor unit (CPU) and/or have one or more programs or program modules. The CPU can be developed to process commands that are implemented as a program stored in a storage system, to acquire data signals from a data bus and/or to send output signals to a data bus. A storage system can have one or several, in particular various storage media, in particular optical, magnetic, solid state media and/or other non-volatile media. The program can can be designed in such a way that it embodies the methods described here or is capable of executing them, so that the CPU can execute the steps of such methods and thereby in particular design and/or operate the robot, and in particular control it.

In one embodiment, designing the robot includes designing a cell and/or application of the robot.

In one embodiment, an information is issued that specifies one or more groups, whose group-specific quantities require an adaptation of the corresponding contacts, for example a reduction in their reflected inertias and/or stiffnesses and/or the increase of a curvature of their contact geometry, for example those groups, where the group-specific quantity exceeds a predefined threshold. Additionally or alternatively, in one embodiment one or more of the identified group-specific quantities are output, in particular they are displayed and/or saved.

### BRIEF DESCRIPTION OF THE DRAWINGS

Other advantages and features arise from the subclaims and the embodiment examples. For this purpose, the following partly schematic figures show:

FIG. 1: A robot with a controller for performing a method according to an embodiment of the present invention; and

FIG. 2: The process of this method.

### DETAILED DESCRIPTION

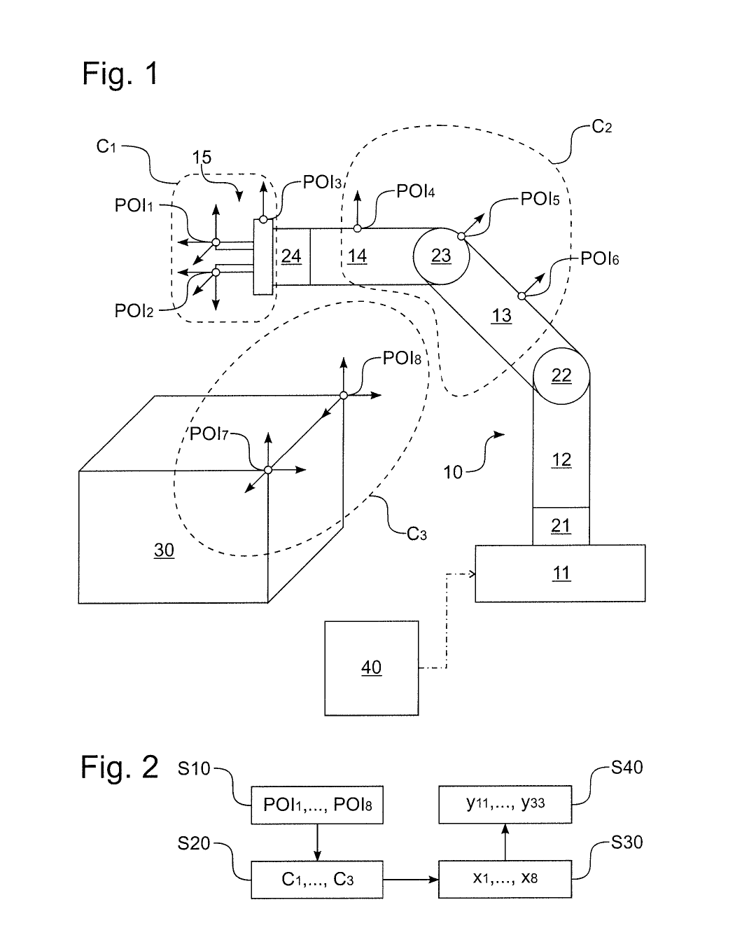

FIG. 1 shows a robot 10 with a base 11, a carousel 12, an arm 13, a hand 14 and a tool in the form of a gripper 15, which are pairwise permanently linked together by flexible joints and actuated by drives 21-24. The links 12-14 connect the base 11 to the tool flange, to which the tool 15 is detachably fastened. A controller 40 monitors and controls the drives 21-24 and has or executes a program for performing a hereinafter described method for designing and/or operating a robot according to an embodiment of the present invention.

According to this method, an initial step S10 (see FIG. 2) determines several potential contacts POI₁ through POI₈. This can take place in a partially or fully automatic procedure, for example, on the basis of CAD data or the like, or also by user input.

The robot-fixed contacts POI₁ and POI₂ describe potential contacts between clamps of the gripper 15 and a person, and in FIG. 1 these are intimated by coordinate systems, which describe potential contact speeds and connection points. Further, parameters of the contacts can describe for example their reflected inertia, their contact stiffness or contact damping, their surface hardness or contact hardness or contact roughness and the like.

The robot-fixed contacts POI₄ and POI₆ describe potential contacts between the hand 14 or the arm 13 and a person, and in FIG. 1 these are intimated by outward normals, which describe potential contact speeds and contact points of these robot links modeled as cylinder primitives. Further, parameters of these contacts can also describe for example their reflected inertia, their contact stiffness and/or contact damping, their surface hardness or contact hardness or contact roughness and the like.

The robot-fixed contacts POI₃ and POI₅ describe potential contacts between a tool baseplate of the tool 15 or of the drive 23 and a person. Since these robot links are also modeled as a cylinder primitive, these contacts POI₃ and POI₅ are also indicated by an outward normal that describe potential contact speeds and contact points. Further, parameters of these contacts can also describe for example their reflected inertia, their contact stiffness and/or contact damping, their surface hardness or contact hardness or contact roughness and the like.

The environment-fixed contacts POI₇ and POI₈ describe potential contacts between a table 30 and a person, and due to the analogous contact geometry they are intimated in the same manner as for POI₁ and POI₂ by means of coordinate systems, which describe potential contact speeds and contact points. Further, parameters of these contacts can also describe for example their reflected inertia, their contact stiffness and/or contact damping, their surface hardness or contact hardness or contact roughness and the like.

In a step S20 the contacts are then optionally or, in a partially of fully automated procedure assigned to different groups C₁ through C₃, which are indicated by dashed lines in FIG. 1.

There group C₁ represents potential contacts of the gripper 15. Accordingly, contacts POI₁ through POI₃ are assigned to this group C₁ in dependence of their fixed position relative to the gripper 15.

Group C₂ represents potential contacts whose position and speed depend only on the joint coordinates of the joints or drives 21 through 23. Accordingly, contacts POI₄ through POI₆ are assigned to this group C₂ in dependence of the joints determining their kinematics.

Group C₃ represents environment-fixed potential contacts whose position and speed does not depend on the joint coordinates of the joints or drives 21 through 23. Accordingly, contacts POI₇ and POI₈ are assigned to this group C₃.

In a step S30, either in advance or during operation of the robot 10, a contact-specific quantity x₁ through x₈ is determined for these contacts POI₇ and POI₈ in dependence of a potential medical harm to a person by the respective contact.

The contact-specific quantity can, for example, specify a speed or reflected inertia in this contact, that is maximum permitted with regard to a potential medical harm to a person by this contact. Likewise, the contact-specific quantity can specify a potential medical harm to a person resulting from this contact.

In a step S40, three group-specific quantities (y₁₁, y₁₂, y₁₃), (y₂₁, y₂₂, y₂₃) or (y₃₁, y₃₂, y₃₃) are then respectively determined for these groups C₁ through C₃ on the basis of the contact-specific quantities of the contacts x₁ through x₈ assigned to these groups. Here the maximum or minimum of the contact-specific quantities x₁ through x₃ are determined as the group-specific quantity y₁₁, for example the maximum of the potential harms x₁ through x₃ or the minimum of the maximum allowable speeds x₁ through x₃. Analogously the maximum or minimum of the contact-specific quantities x₄ through x₆ are determined as the group-specific quantity y₂₁, for example the maximum of the potential harms x₄through x₆ or the minimum of the maximum allowable speeds x₄ through x₆. Analogously the maximum or minimum of the contact-specific quantities ₓ₇, x8 are determined as the group-specific quantity y₃₁, for example the maximum of the potential harms x₇, x₈ or the minimum of the maximum allowable speeds x₇, x₈. These group-specific quantities y₁₁, y₂₁ and y₃₁ are thus determined on the basis of a comparison of the respective contact-specific quantities (x₁, x₂, x₃), (x₄, x₅, x₆) or (x₇, x₈) with each other within the group C₁, C₂ or C₃.

The number of contact-specific variables x₁ through x₃, which exceed or fall below a predetermined threshold value, for example exceeding an upper threshold value for a potential harm or falling below a lower threshold value for a maximum allowable speed, are determined as the group-specific quantity y₁₂. Analogously, the number of contact-specific quantities x₄ through x₆, which exceed or fall below this threshold value, is determined as the group-specific quantity y₂₂. Analogously, the number of contact-specific quantities x₇, x₈, which exceed or fall below this threshold value, is determined as the group-specific quantity y₃₂. These group-specific quantities y₁₂, y₂₂ and y₃₂ are thus based on a comparison between the respective contact-specific variables (x₁, x₂, x₃), (x₄, x₅, x₆) or (x₇, x₈) and a predetermined threshold value within the group C₁, C₂ or C₃.

The mean value of the contact-specific quantities x₁ through x₃ is determined as the group-specific quantity y₁₃. Analogously, the mean value of the contact-specific quantities x₄ through x₆ is determined as the group-specific quantity y₂₃, and the mean value of the contact-specific quantities x₇, x₈ as the group-specific quantity y₃₂. These group-specific quantities y₁₃, y₂₃ and y₃₃ are therefore based on an averaging of contact-specific quantities within the group C₁, C₂ or C₃.

Then, in step S40, the group-specific quantities (y₁₁, y₂₁ and y₃₁) are compared with each other, likewise the group-specific quantities (y₁₂, y₂₂ and y₃₂) with each other and the group-specific quantities (y₁₃, y₂₃ and y₃₃) with each other. Additionally or alternatively, the group-specific quantities (y₁₁, y₂₁ and y₃₁), (y₁₂, y₂₂ and y₃₂) and/or (y₁₃, y₂₃ and y₃₃) are each compared with a predetermined threshold value.

In this way it is possible to identify which of the groups C₁, C₂ or C₃ for example has the highest maximum or mean hazard potential or limits the maximum allowable speed most strongest or influentially, i.e. because of many potential contacts.

Then these groups can be specifically optimized. In particular, information can then be output, which indicates that these groups should or must be optimized or considered.

For example, if a comparison of the group-specific quantities reveals that group C₁ has the highest maximum or mean hazard potential or limits the maximum permissible speed most strongly or significantly, a different gripper can be selected specifically or the gripper can be optimized. If a comparison of the group-specific quantities reveals, for example, that group C₂ has the highest maximum or mean hazard potential or limits the maximum permissible speed most strongly or significantly, a movement in the joints 21 through 23 can be specifically optimized. In particular, information can then be output, which indicates that these joints 21 through 23 should or must be optimized or considered. If a comparison of the group-specific quantities reveals, for example, that group C₃ has the highest maximum or mean hazard potential or limits the maximum permissible speed most strongly or significantly, the table 30 can be replaced or repositioned.

Although the foregoing description explains exemplary embodiments, it should be noted that a large number of variations are possible.

Thus in the embodiment example, in particular the contact-specific quantities were already determined on the basis of a risk assessment. Similarly, as explained in the introduction, in a modification it is possible to first determine contact-specific quantities that determine a potential medical harm to a person due to a respective contact, however still without a hazard assessment, for example, the contact speeds or inertias. Then the group-specific quantities can be determined in dependence of a potential medical harm to a person due to the contacts of the particular group, for example, the contact speeds that exceed a maximum permissible speed for avoiding an impermissible injury to a person. It should also be noted that the exemplary embodiments are mere examples only, and in no way at all do they limit the scope of the protection, the applications and the structure. Rather, the skilled person will find in the foregoing description a guide for implementing at least one exemplary embodiment, whereby various changes, in particular with respect to the function and arrangement of the described components may be made without departing from the scope of protection derived from the claims and these equivalent combinations of features.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

### LIST OF REFERENCE NUMBERS

10 Robot

11 Base

12 Carousel

13 Arm

14 Hand

15 Gripper (tool)

21-24 Joint (drive)

30 Table

40 Controller

POI₁-POI₈ Potential contact

C₁-C₃ Group

x₁-x₈ Contact-specific quantity

y₁₁-y₃₃ Group-specific quantity

What is claimed is:

1. A method for designing and/or operating a robot, whereby several potential contacts are determined and a contact-specific quantity is established for each of these contacts;
the contacts are assigned to different groups; and
in particular, for selected groups, in each case, at least one group-specific quantity is determined on the basis of contact-specific quantities of contacts assigned to this group;
whereby the contact-specific quantities and/or at least one group-specific quantity are determined depending on a potential medical harm to a person.

2. The method according to claim 1, wherein a group-specific quantity is determined on the basis of a comparison between contact-specific quantities with each other within the group.

3. The method according to claim 1, wherein a group-specific quantity is determined on the basis of a comparison between contact-specific quantities and at least one predefined threshold value within the group.

4. The method according to claim 1, wherein a group-specific quantity is determined on the basis of an averaging of contact-specific quantities within the group.

5. The method according to claim 1, further comprising comparing group-specific quantities with each other and/or with at least one predetermined threshold value.

6. The method according to claim 1, wherein contacts are assigned to groups depending on their position relative to structural elements, in particular components or component groups of the robot and/or the joint coordinates of the robot determining their kinematics.

7. The method according to claim 1, wherein contacts can be optionally assigned to groups.

8. The method according to claim 1, wherein a group-specific and/or contact-specific quantity indicates a potential medical harm to a person.

9. The method according to claim 1, wherein a group-specific and/or contact-specific quantity specifies a, in particular permissible, kinematic quantity, in particular geometry, position, speed and/or acceleration, and/or a, in particular permissible, dynamic quantity, in particular stiffness, damping and/or inertia.

10. The method according to claim 1, further comprising determining a contact geometry, a kinematic contact quantity, in particular a position, an orientation and/or a speed and/or a dynamic contact quantity, in particular a contact stiffness, contact damping and/or inertia for a contact, if the latter is specified.

11. The method according to claim 1, wherein the method is performed, in at least a partially automated procedure during robot operation and/or in advance.

12. The method according to claim 1, wherein at least one of the contacts is robot-fixed or environment-fixed.

13. Means for designing and/or operating a robot, wherein the means is set up to perform, in at least a partially automated procedure, a method according to claim 1.

14. A computer-program product with a program code that is stored on a computer-readable medium, for performing a method according to claim 1.
